(19) United States
(12) Patent Application Publication
(10) Pub. No.: US 2006/0114494 A1
(43) Pub. Date: Jun. 1, 2006

(54) Methods and apparatus for accounting information processing for networked printing systems

(75) Inventors: Scott Crosby, Foster City, CA (US); John Armstrong, Half Moon Bay, CA (US)

Correspondence Address: LAW OFFICE OF JAMES TROSINO, 92 NATOMA STREET, SUITE 211, SAN FRANCISCO, CA, 94105, US

(73) Assignee: Electronics for Imaging, Inc.

(21) Appl. No.: 10/999,535

(22) Filed: Nov. 29, 2004

(51) Int. Cl. G06F 3/12

(52) U.S. Cl. 358/1.15

(57) ABSTRACT

Methods and apparatus are provided for networked printing systems that include a client computer coupled via a print server to a plurality of network printers. Each network printer is coupled to an associated accounting server that requires pre-print information for billing purposes. The client computer sends the print server a print request that designates one of the network printers to print a document. The print server creates a print job based on the document, determines the pre-print information required by the associated accounting server, and prompts a user of the client computer to provide the required information. The print server creates a pre-print message based on the user's response in accordance with a pre-print protocol, and then sends the pre-print message to the associated accounting server. If the accounting server authorizes the print job, the print server sends the print job to the designated network printer for printing. After the print job has been printed, the print server receives print summary information from the designated network printer, and then creates a post-print message based on the print summary information in accordance with a post-print protocol. The print server sends the post-print message to the associated accounting server, which may use the post-print information to bill the user for printing the print job.

### BACKGROUND

This invention relates to networked printing systems. More particularly, this invention relates to methods and apparatus for providing pre-print authorization and post-print notification information for printers used in networked printing systems.

In recent years, the availability and use of mobile computing equipment, such as laptop computers, handheld computers, personal digital assistants and web-enabled wireless telephones (collectively referred to herein as “mobile computers”), has increased at a phenomenal rate. As mobile computer use has become more prevalent, the need for “mobile printing” has also increased. For example, a person editing a document on a laptop computer at a coffee shop may want to print a paper copy of the revised document for final review. Similarly, a person checking email on a handheld computer at an airport may want to obtain a hardcopy print of particular email messages for archival purposes. Likewise, a person browsing the web on a wireless telephone at a hotel may want to print copies of specific web pages for subsequent offline reading.

To meet this growing need, several networked printing systems have been developed in recent years. For example, EFI PrintMe™, by Electronics for Imaging, Inc. (“EFI”), Foster City, Calif., U.S.A., is an Internet printing system that allows anyone with Internet or email access to print documents and web content to any printer coupled to the PrintMe network. In addition, PrinterOn™, by PrinterOn Corporation, Kitchener, Ontario, Canada, also provides an Internet printing system that allows users with Internet access to print documents at printers coupled to the PrinterOn network. Such networked printing systems typically use a networked print server that receives print job requests from client computers, and then forwards print jobs to designated printers coupled to the network (referred to herein as “network printers”).

A networked print system provider (e.g., EFI) typically maintains the networked print server, and third party providers typically maintain the network printers to provide printing services for their end user customers. For example, a hotel may install network printers in guest rooms, at the front desk, or in a hotel business center to provide networked printing services for hotel guests. Similarly, an airline may install network printers in a frequent traveler lounge to provide networked printing services for airline passengers. Likewise, a coffee shop may install network printers in the cafe to provide networked printing services for its customers. As more third parties have installed network printers, a “global” printing network has been developed that allows individual users to print documents at any network printer.

Referring now to FIG. 1, an example of such a networked printing system is described. Networked printing system 10 includes client computers 12 coupled via network 14 to print server 16, which also is coupled via network 14 to network printers 18. Each client computer 12 includes a document 20 and a print job submission interface 22, which may be a web interface, an email interface, a printer driver or other similar interface that permits a user to submit a document 20 to print server 16 for printing, and to designate the network printer 18 that will be used for printing. Print server 16 may be a computer that receives documents 20 and printer designations from users of client computers 12, converts the documents to print jobs, and then forwards the print jobs to the designated network printers 18 for printing.

Network printers 18a-18c may be print devices that are operated by third party providers. For example, network printer 18a may be a black-and-white printer operated by Company A at a coffee shop in Los Angeles. Network printer 18b may be a color printer operated by Company B at the front desk of a hotel in Rome. Network printer 18c may be a color printer operated by Company C at a premium frequent flyer lounge in Paris.

Although any user of client computers 12 may submit documents 20 to print server 16 for printing on any of network printers 18, some third party providers that operate network printers 18 may restrict printing to those end users who are the provider's actual customers. For example, Company A may restrict printing on network printer 18a to customers in the coffee shop, Company B may restrict printing on network printer 18b to hotel guests, and Company C may restrict printing on network printer 18c to travelers in the frequent flier lounge.

Additionally, each third party provider typically charges a fee for printing on the provider's network printers 18, according to the provider's own unique fee structure and billing policy. For example, Company A may charge a per-page printing fee for all pages printed on network printer 18a, Company B may charge a flat fee for use of network printer 18b, regardless of the number of printed pages, and Company C may charge a first per-page printing fee for all black-and-white pages printed on network printer 18c, and a second per-page fee for all color pages printed on the printer.

Each third party provider typically uses an accounting server 24 coupled to the provider's network printers 18 to implement such user billing techniques. For example, accounting server 24a may charge the per-page printing fee to a user's credit or debit card. Accounting server 24b, in contrast, may include any printing fee charges in a guest's bill at checkout. Accounting server 24c may allow a user to charge any printing fees either to the user's credit card or frequent flier account. To accomplish such billing processes, each third party provider therefore typically requires user-supplied pre-print information that will be used to charge the user for printing fees, and system-supplied post-print information that describes the resulting printed output.

Examples of pre-print and post-print information for networked printing system 10 are illustrated in FIG. 2. In particular, for Company A, pre-print information includes the user's name, credit/debit card number, and card expiration date. Accounting server 24a may use this pre-print information to seek approval for the charges from the bank that issued the card. If the issuing bank approves the charges, accounting server 24a then allows the user to print a document on network printer 18a. For post-print information, Company A requires the total number of printed pages, so that accounting server 24a may then calculate the total printing fee to be charged to the user's credit/debit card.

In contrast, for Company B, pre-print information includes the user's name and room number. Accounting server 24b may use this pre-print information to seek approval for the charges from the hotel's billing system. If the billing system approves the charges, accounting server 24b then allows the user to print a document on network printer 18b. For post-print information, Company B requires an indication that any pages were actually printed, so that accounting server 24b may then add the flat rate printing fee to the user's hotel bill.

For Company C, pre-print information includes the user's name, and a selection of credit/debit card or frequent flier account. If the user indicates that printing fees should be charged to a credit/debit card, the user must provide the credit/debit card number and card expiration date. If, however, the user indicates that printing fees should be charged to a frequent flier account, the user must provide the frequent flier account number and personal identification number (“PIN”). Accounting server 24c may then use this pre-print information to seek approval for the charges from the issuing bank or from the frequent flier accounting system. If the charges are approved, accounting server 24c then allows the user to print a document on network printer 18c. For post-print information, Company C requires an indication of the total number of black-and-white and color pages printed, so that accounting server 24c may then calculate the total printing fee to be charged to the user's credit/debit card or frequent flier account.

In these examples, each third party provider requires specific pre-print and post-print information, but the information requirements of each provider differ from that of other providers. In previously known networked printing systems, this has typically required that the networked print system provider develop customized accounting interfaces for each third party provider, with each accounting interface tailored to the third party provider's specific pre-print and post-print information requirements.

Thus, in exemplary networked print system 10, print server 16 may include first, second and third accounting interfaces 26a, 26b and 26c, respectively, for Companies A, B and C, respectively. In such a system, as each third party provider is added to the system, the networked print system provider must develop and maintain an additional accounting interface 26 for that provider. Such customized systems are costly and inefficient, and undercut the goal of providing a truly universal networked printing system.

In view of the foregoing, it would be desirable to provide standardized accounting interfaces for providing pre-print authorization and post-print notification information for printers used in networked printing systems.

### SUMMARY

In view of the foregoing, it is an object of this invention to provide standardized accounting interfaces for providing pre-print authorization and post-print notification information for printers used in networked printing systems.

These and other objects of this invention are accomplished by systems and methods for use with networked printing systems that include a client computer coupled via a print server to a plurality of network printers, wherein each network printer is coupled to an associated accounting server that requires corresponding pre-print information for billing purposes. In particular, the print server receives a print request from the client computer, wherein the print request designates one of the network printers to print a document. The print server uploads the document, creates a print job based on the document and determines the required pre-print information corresponding to the accounting server associated with the designated network printer. The print server prompts the user of the client computer to provide the required pre-print information, and then creates a pre-print message based on the user's response and in accordance with a pre-print protocol. The print server sends the pre-print message to the associated accounting server.

The accounting server may use the received information to determine if the user is authorized to print, and then sends the print server a message indicating whether the user is so authorized. If so, the print server sends the print job to the designated network printer, which prints the print job. After printing the print job, the designated printer sends print summary information to the print server, which creates a post-print message based on the print summary information, and in accordance with a post-print protocol. The print server sends the post-print message to the associated accounting server, which may use the information in the post-print message to bill the user for printing the print job.

### BRIEF DESCRIPTION OF THE DRAWINGS

The above-mentioned objects and features of the present invention can be more clearly understood from the following detailed description considered in conjunction with the following drawings, in which the same reference numerals denote the same elements throughout, and in which:

FIG. 1 is a block diagram of a previously known networked printing system;

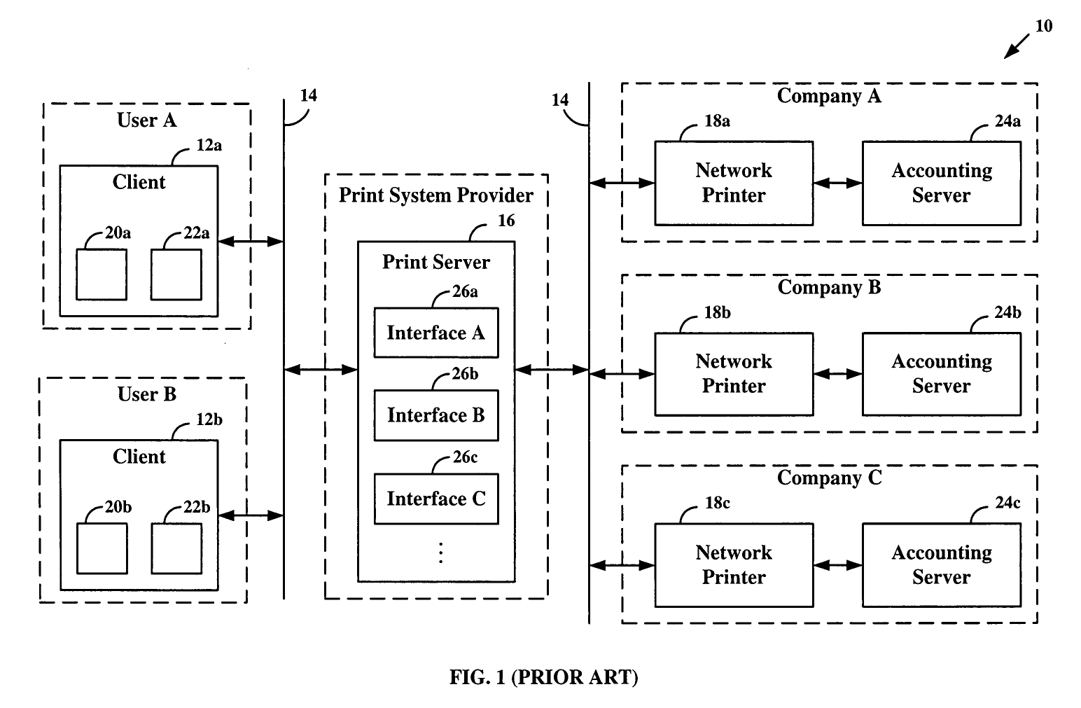

FIG. 2 is a table illustrating exemplary previously known pre-print and post-print information requirements;

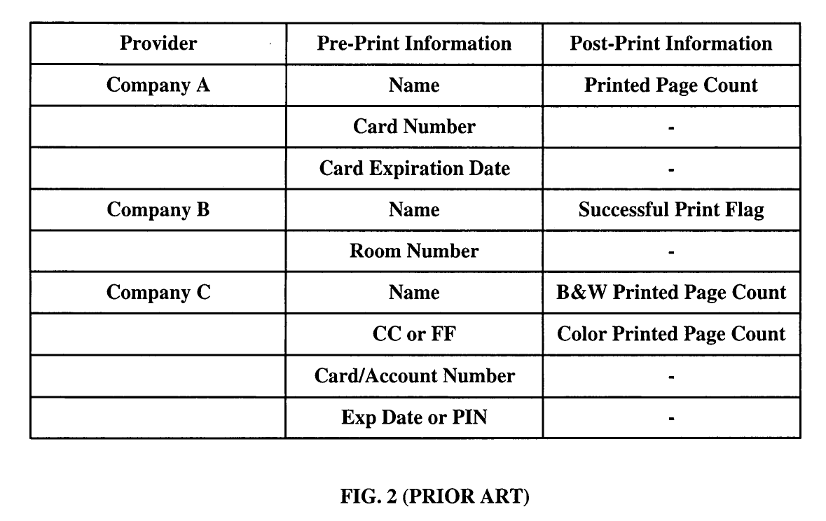

FIG. 3 is a block diagram of an exemplary networked printing system in accordance with this invention;

FIG. 4 is a diagram of an exemplary accounting database in accordance with this invention;

FIG. 5 is a diagram of an exemplary pre-print protocol in accordance with this invention;

FIGS. 6A-6C are diagrams of exemplary field definitions of pre-print messages in accordance with this invention;

FIG. 7 is a diagram of an exemplary post-print protocol in accordance with this invention.

### DETAILED DESCRIPTION

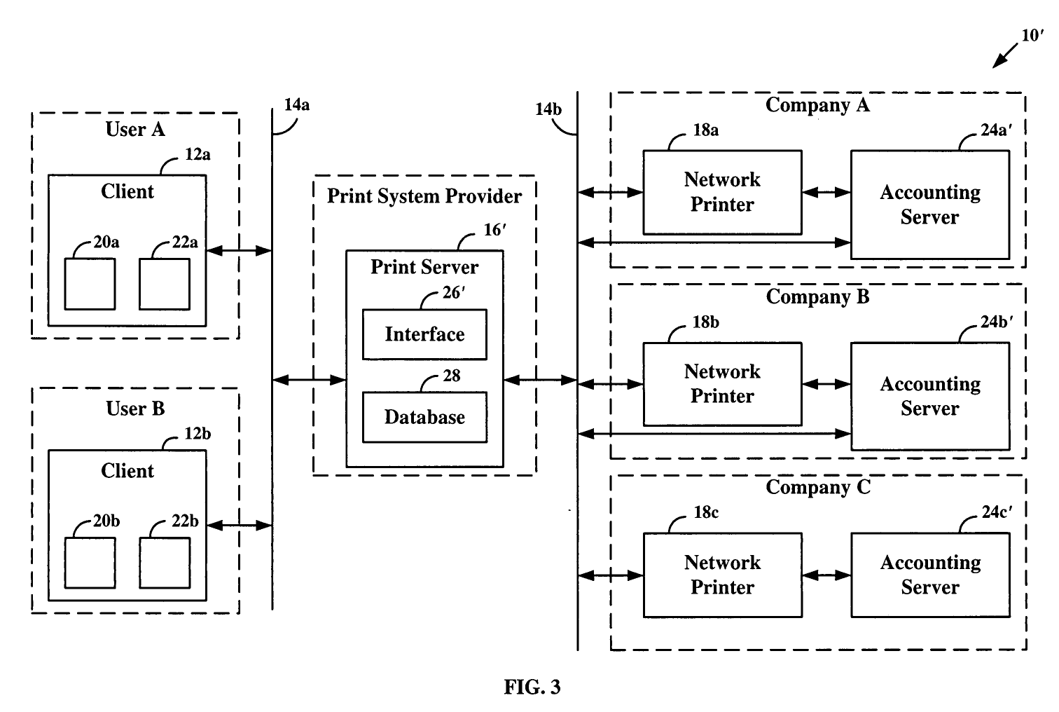

Referring now to FIG. 3, an exemplary networked printing system in accordance with this invention is described. Networked printing system 10′ includes client computers 12 coupled via network 14a to print server 16′, which also is coupled via network 14b to network printers 18 and associated accounting servers 24′. Client computers 12 each include a document 20 and a print job submission interface 22, which may be a web browser, email client, print driver, or other similar interface for submitting print requests to print server 16′. Persons of ordinary skill in the art will understand that each of client computers 12 may include more than one document 20 and more than one type of print job submission interface 22.

Networks 14a and 14b each may be a local area network, wide area network, wired network, wireless network, satellite network, cellular network, public switched telephone network, public network, the Internet, or combination of such networks. Networks 14a and 14b may be different networks or combination of networks, or may be the same network or combination of networks. For simplicity, the following discussion assumes that networks 14a and 14b are the same network 14, such as the Internet.

Print server 16′ may be a personal computer, laptop computer, computer workstation, or other similar computer device that receives print requests from print job submission interfaces 22, where each print request designates a specific network printer 18 for printing. Network printers 18 may be printers, copiers, plotters, facsimile machines, printing presses, print controllers or other similar print devices, or combinations of such print devices. For example, print device 18a may be a black-and-white printer, print device 18b may be a color printer and print device 18c may be a print controller, such as a Fiery®, EDOX® or Splash® print controller by Electronics for Imaging, Inc., Foster City, Calif., U.S.A. Network printers 18 may include networked printing system hardware and/or software, such as PrintMe hardware and/or software. Such networked printing hardware and/or software may be embedded into a print device, or may be included in a separate standalone device coupled to the print device.

Each network printer 18 is coupled to an associated accounting server 24′, which may be a personal computer, laptop computer, computer workstation, or other similar computer device. For example, network printers 18a-18c are coupled to associated accounting servers 24a′-24c′, respectively. Each accounting server 24′ performs billing functions for the associated network printers 18, and may require specific pre-print information. The required pre-print information may include “billing” pre-print information, such as user name, credit card number, email address and other similar billing information, and “job” pre-print information, such as page count, number of cover pages, and other similar information about the print job that is to be printed. Each accounting server 24′ may be directly coupled to network 14, or may be coupled to network 14 via associated network printers 18.

In accordance with this invention, for each received print request, print server 16′ determines the pre-print information required by the accounting server 24′ associated with the designated network printer 18. Next, print server 16′ prompts the user via print job submission interface 22 to provide any required billing pre-print information, and to select one or more documents 20 to print. After receiving the user's response, print server 16′ uploads the documents 20, converts the uploaded documents to a print job, calculates job pre-print information, creates a pre-print message in accordance with a pre-print protocol, and sends the pre-print message to the associated accounting server 24′. After receiving the pre-print message, the accounting server 24′ may simply store the received information, or may use the information to confirm that the user is authorized to print on the designated network printer 18. The accounting server 24′ then returns an authorization response (e.g., Allow or Deny) to print server 16′, indicating whether the user may print on the designated network printer 18.

If the authorization response indicates that printing is allowed, print server 16′ then forwards the print job to the designated network printer 18 for printing. After printing has completed, the designated network printer 18 sends post-print information to print server 16′, which creates a post-print message in accordance with a post-print protocol, and then sends the post-print message to the associated accounting server 24′. The accounting server 24′ retrieves the post-print information from the received message, and then uses the retrieved information to calculate printing charges in accordance with the server's billing process.

Print server 16′ may include accounting interface 26′ and accounting database 28 to perform pre-print and post-print information processing in accordance with this invention. Accounting database 28 may include information specifying the accounting server 24′ associated with each network printer 18, and the pre-print information requirements corresponding to each accounting server 24′. Accounting interface 26′ may be hardware and/or software that may be used to search accounting database 28 to determine the pre-print information required by the accounting server 24′ associated with the designated network printer 18.

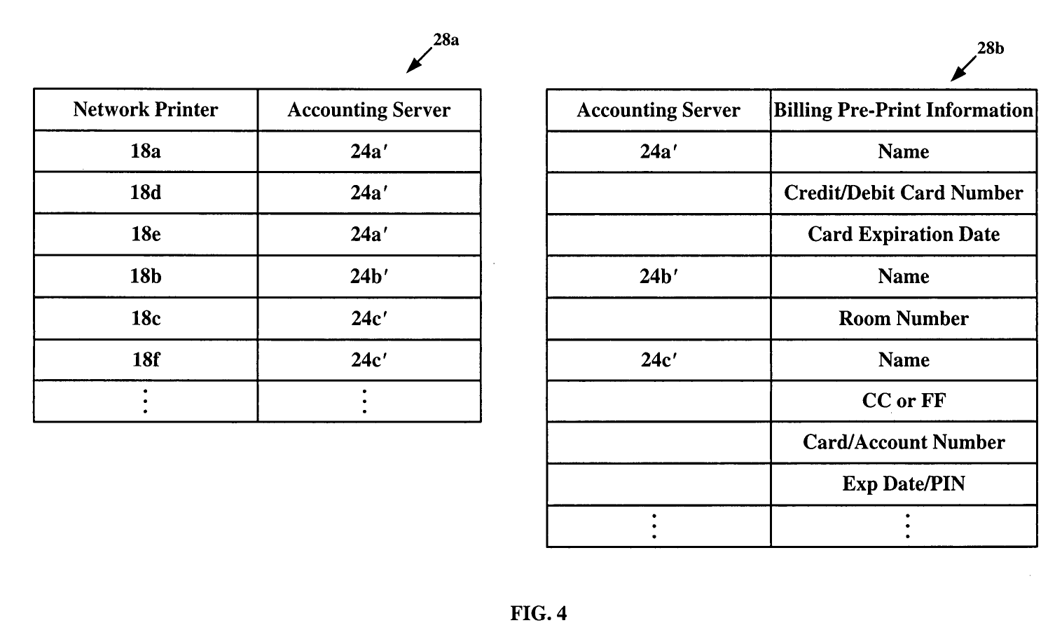

An exemplary accounting database 28 is illustrated in FIG. 4, which includes a first table 28a that cross-references network printers 18 to associated accounting servers 24′, and a second table 28b that cross-references accounting servers 24′ to corresponding billing pre-print information requirements. As second table 28b illustrates, each accounting server 24′ may have a unique set of corresponding billing pre-print information requirements. Persons of ordinary skill in the art will understand that accounting database 28 may use formats other than that shown in FIG. 4 for cross-referencing network printers 18 to accounting servers 24′ and corresponding billing pre-print information requirements.

Referring now to FIGS. 3 and 4, after print server 16′ receives a print request from a client computer 12, accounting interface 26′ retrieves the name of the designated network printer 18 from the print request, searches first table 28a to identify the accounting server 24′ associated with the designated network printer 18, and searches second table 28b to identify the corresponding billing pre-print information required by the identified accounting server 24′. For example, if the user's print request designates network printer 18b, accounting interface 26′ searches first table 28a, and determines that accounting server 24b′ is associated with network printer 18b. Accounting interface 26′ then searches second table 28b, and determines that accounting server 24b′ requires a user name and room number. Accounting interface 26′ then prompts the user via print job submission interface 22 to provide a name and room number, and then creates a pre-print message based on the user's response in accordance with the pre-print protocol.

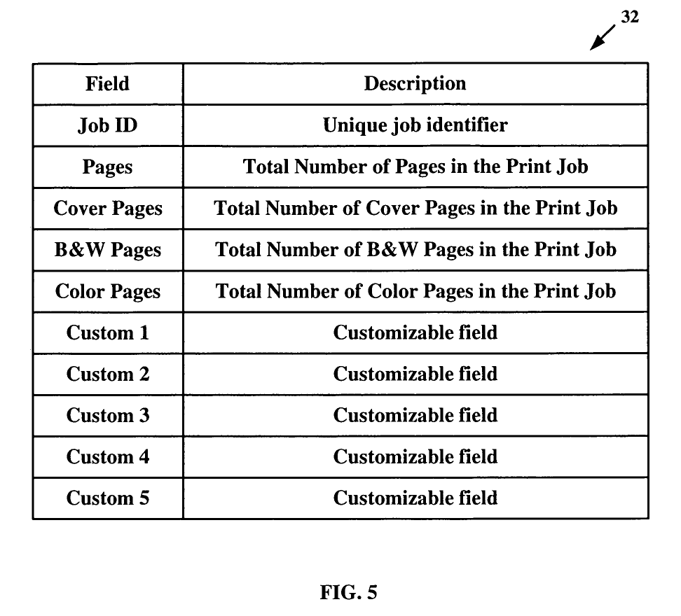

An exemplary pre-print protocol is illustrated in FIG. 5. Exemplary pre-print protocol 32 includes ten fields, the first five of which include system-generated job pre-print information, and the last five of which include user-supplied billing pre-print information. In particular, the fields are: “Job Id,” which is an alpha-numeric code that uniquely identifies the print job, “Pages,” which is the total number of pages in the print job, “Cover Pages,” which is the total number of cover pages in the print job, “B&W Pages,” which is the total number of black-and-white pages in the print job, “Color Pages,” which is the total number of color pages in the print job, and “Custom 1”-“Custom 5,” which are customizable fields that may be used to specify the corresponding billing pre-print information required by accounting servers 24′. Because the billing pre-print information requirements of each accounting server 24′ may be unique, pre-print messages created in accordance with the pre-print protocol have field definitions that may be customized to the specific billing pre-print information requirements of each accounting server 24′.

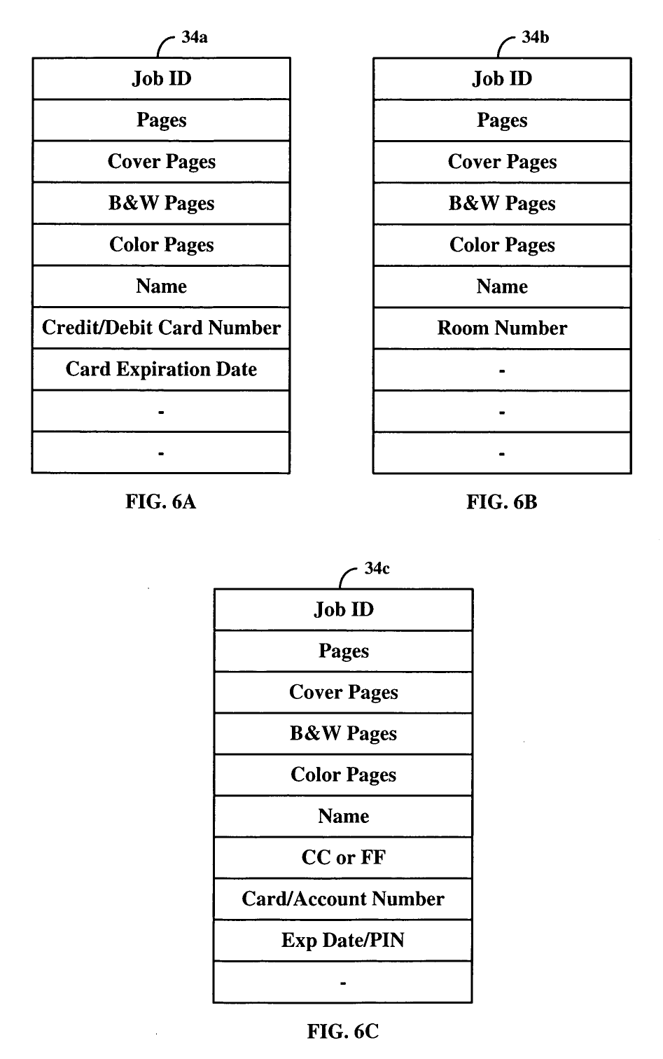

For example, referring now to FIGS. 6A-6C, the field definitions of exemplary pre-print messages intended for accounting servers 24a′-24c′, respectively, are described. In particular, as shown in FIG. 6A, the first eight fields of pre-print message 34a are: “Job Id,” “Pages,” “Cover Pages,” “B&W Pages,” “Color Pages,” “Name,” “Credit/Debit Card Number,” and “Card Expiration Date,” and the last two fields are unused. In contrast, as shown in FIG. 6B, the first seven fields of pre-print message 34b are “Job Id,” “Pages,” “Cover Pages,” “B&W Pages,” “Color Pages,” “Name,” and “Room Number,” and the last three fields are unused. As shown in FIG. 6C, the first nine fields of pre-print message 34c are “Job Id,” “Pages,” “Cover Pages,” “B&W Pages,” “Color Pages,” “Name,” “CC or FF,” “Card/Account Number,” and “Exp Date/PIN,” and the last field is unused.

Thus, the pre-print protocol may be used for all pre-print messages for all accounting servers 24′. By including customizable fields in the pre-print protocol, networked printing system 10′ may accommodate a wide variety of pre-print information requirements of all accounting servers 24′. Persons of ordinary skill in the art will understand that pre-print protocol 32 may include more than or less than ten fields, may include more than or less than five customizable fields, and may include fields other than those shown in FIG. 5.

An example of the operation of pre-print information processes in accordance with this invention is now described. Referring again to FIGS. 3, 4 and 6B, if User A submits a print request to print server 16′ that designates network printer 18b, accounting interface 26′ determines from first table 28a that accounting server 24b′ is associated with network printer 18b, and then determines from second table 28b that accounting server 24b′ requires that a user provide a name and room number. Accordingly, accounting interface 26′ prompts User A via print job submission interface 22a to provide this billing pre-print information, and to select one or more documents to print. If the user responds with a name “Rita Hayworth,” and a room number “1227,” and selects document 20a, print server 16′ uploads document 20a, converts the uploaded document to a print job, and calculates the total number of pages, black-and-white pages and color pages in the print job.

For example, if the print job includes eleven pages, including one cover page, eleven black-and-white pages and no color pages, and if the system specifies a Job ID of “IA2N8c7,” accounting interface 26′ will create the following pre-print message:

$$\begin{matrix}1 A 2 N 8 c 7 \\ 11 \\ 1 \\ 11 \\ 0 \\ Rita Hayworth \\ 1227 \\ \text{-} \\ \text{-} \\ \text{-} \\ \text{-}\end{matrix}$$

where each “-” represents a blank field. Accounting interface 26′ then sends this pre-print message (e.g., via an http request) to accounting server 24b′, which reads the received pre-print message in accordance with pre-print message 34b, and therefore determines that the Job ID is “1A2N8c7,” the job includes a total of eleven pages, including one cover page, eleven black-and-white pages and no color pages, the name is “Rita Hayworth,” and the room number is “1227.”

Alternatively, referring to FIGS. 3, 4 and 6C, if User B submits to print server 16′ a print request that designates network printer 18c, accounting interface 26′ determines from first table 28a that accounting server 24c′ is associated with network printer 18c, and then determines from second table 28b that accounting server 24c′ requires that a user provide a name, specify whether print fees should be charged to a credit/debit card or a frequent flier account, and provide the card/account number and the expiration date/PIN. Accordingly, accounting interface 26′ prompts User B via print job submission interface 22b to provide this pre-print information, and to select one or more documents to print. If the user responds with a name “Clark Gable,” a billing selection of “Credit Card,” a card number of “1234-5678-9012-3456,” an expiration date of “02/2007,” and selects document 20b, print server 16′ uploads document 20b, converts the uploaded document to a print job, and calculates the total number of pages, black-and-white pages and color pages in the print job.

For example, if the print job includes fifteen pages, including no cover pages, two black-and-white pages and thirteen color pages, and if the system specifies a Job ID of “qt8vP5S,” accounting interface 26′ will create the following pre-print message:

$$\begin{matrix}qt 8 vP 5 S \\ 15 \\ 0 \\ 2 \\ 13 \\ Clark Gable \\ Credit Card \\ 1234 \text{-} 5678 \text{-} 9012 \text{-} 3456 \\ 02 \text{/} 2007 \\ \text{-}\end{matrix}$$

where each “-” represents a blank field. Accounting interface 26′ then sends this pre-print message (e.g., via an http request) to accounting server 24b′, which reads the received pre-print message in accordance with pre-print message 34c, and therefore determines that the Job ID is “qt8vP5S,” the job includes a total of fifteen pages, including no cover page, two black-and-white pages and thirteen color pages, that the name is “Clark Gable,” the billing selection is “Credit Card,” the card number is “1234-5678-9012-3456,” and the expiration date is “02/2007.” Thus, accounting interface 26′, accounting database 28 and the pre-print protocol may be used to create pre-print messages that may be used with all accounting servers 24′.

Referring again to FIG. 3, after sending a pre-print message, print server 16′ waits for a print authorization response from the associated accounting server 24′. If the response indicates that printing is allowed, print server 16′ sends the print job to the designated network printer 18 for printing. After printing has completed, the designated network printer 18 sends print summary information to print server 16′.

Exemplary print summary information provided by network printers 18 may include the total number of pages printed, the total number of black-and-white pages printed and the total number of color pages printed. In particular, based on the specific type of network printer 18, some of this information may not be available or relevant. For example, a black-and-white network printer 18 will only be able to provide the total number of black-and-white pages printed. In such cases, inapplicable print summary information may be ignored.

After receiving the print summary information from the designated network printer 18, print server 16′ creates a post-print message in accordance with a post-print protocol, and then sends the post-print message (e.g., via an http request) to the accounting server 24′ associated with the designated network printer 18. In particular, accounting interface 26′ may create the post-print message and then send the post-print message to the associated accounting server 24′.

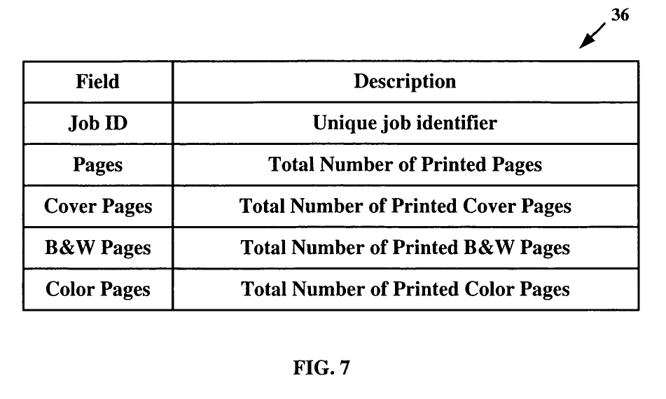

An exemplary post-print protocol is illustrated in FIG. 7. In particular, post-print protocol 36 includes six fields: “Job Id,” which is the same code used in the corresponding pre-print message, “Pages,” which is the total number of pages printed, “Cover Pages,” which is a number of cover pages used in the system, “B&W Pages,” which is the total number of black-and-white pages printed and “Color Pages,” which is the total number of color pages printed.

Each accounting server 24′ may ignore any post-print information that is not required by the specific post-print information requirements of the accounting server 24′. For example, if accounting server 24a′ does not charge a printing fee for cover pages, the accounting server may simply ignore the value in the Cover Pages field. Further, each accounting server 24′ may use the post-print information as a proxy for other information required by the accounting server. For example, if accounting server 24b′ charges a flat rate for printing, regardless of the number of printed pages, the accounting server may use any of the Pages field as a proxy for indicating whether any pages had actually been printed.

An example of the operation of post-print information processes in accordance with this invention is now described. In particular, referring to FIGS. 3 and 7, and continuing the example described above, if User B selected document 20b for printing on network printer 18c, and the network printer actually printed only six pages, including two black-and-white pages, and four color pages, accounting interface 26′ may create the following post-print message:

$$\begin{matrix}qt 8 vP 5 S \\ 6 \\ 0 \\ 2 \\ 4\end{matrix}$$

Accounting interface 26′ then sends this post-print message (e.g., via an http request) to accounting server 24c′, which reads the received post-print message in accordance with the second protocol, and therefore retrieves the Job ID “qt8vP5S,” the total number of printed pages “6,” the number of cover pages “0,” the total number of black-and-white pages “2,” and the total number of color pages “4.” Accounting server 24c′ may then use this information to calculate printing charges for this print job.

The foregoing merely illustrates the principles of this invention, and persons of ordinary skill in the art can make various modifications without departing from the scope and spirit of this invention. For example, in the exemplary embodiments described above, if a network printer 18 and associated accounting server 24′ are located behind a firewall, and the network printer 18 includes a PrintMe station, print server 16′ and the accounting server 24′ may communicate via the PrintMe station, and thereby overcome any communication restrictions that normally arise in connection with firewalls. Such PrintMe stations are described in U.S. Pat. No. 6,748,471, the disclosure of which is incorporated by reference herein in its entirety.

1. A networked printing system comprising:
a plurality of network printers, each network printer coupled to an associated accounting server that requires corresponding pre-print information;
a client computer adapted to generate a print request that designates one of the network printers to print a document; and
a print server comprising an accounting interface adapted to receive the print request, determine the required pre-print information corresponding to the accounting server associated with the designated network printer, prompt a user of the client computer to provide the required pre-print information and create a pre-print message based on the user's response in accordance with a pre-print protocol.

2. The system of claim 1, wherein the required pre-print information comprises a user name.

3. The system of claim 1, wherein the required pre-print information comprises an account number.

4. The system of claim 1, wherein the required pre-print information comprises a personal identification number.

5. The system of claim 1, wherein the required pre-print information comprises a room number.

6. The system of claim 1, wherein the required pre-print information comprises an expiration date.

7. The system of claim 1, wherein the required pre-print information comprises an email address.

8. The system of claim 1, wherein the print server further comprises an accounting database that cross-references each network printer to the associated accounting server.

9. The system of claim 1, wherein the print server further comprises an accounting database that cross-references each accounting server to the corresponding required pre-print information.

10. The system of claim 1, wherein the pre-print protocol comprises a plurality of fields.

11. The system of claim 1, wherein the pre-print protocol comprises a customizable field.

12. The system of claim 1, wherein the accounting interface is further adapted to send the pre-print message to the associated accounting server.

13. The system of claim 12, wherein the accounting interface sends the pre-print message via an http request.

14. The system of claim 12, wherein the accounting interface is further adapted to wait for a print authorization message from the associated accounting server.

15. The system of claim 1, wherein the accounting interface is further adapted to receive print summary information from the designated printer, and use the received print summary information to create a post-print message in accordance with a post-print protocol.

16. The system of claim 15, wherein the post-print protocol comprises a plurality of fields.

17. The system of claim 15, wherein the post-print message comprises a total number of pages printed by the designated printer.

18. The system of claim 15, wherein the post-print message comprises a total number of cover pages printed by the designated printer.

19. The system of claim 15, wherein the post-print message comprises a total number of black-and-white pages printed by the designated printer.

20. The system of claim 15, wherein the post-print message comprises a total number of color pages printed by the designated printer.

21. A printing process for use with a client computer coupled to a plurality of network printers, each network printer coupled to an associated accounting server that requires corresponding pre-print information, the process comprising:
receiving a print request that designates one of the network printers to print a document;
determining the required pre-print information corresponding to the accounting server associated with the designated network printer;
prompting a user of the client computer to provide the required pre-print information; and
creating a pre-print message based on the user's response in accordance with a pre-print protocol.

22. The process of claim 21, wherein the required pre-print information comprises a user name.

23. The process of claim 21, wherein the required pre-print information comprises an account number.

24. The process of claim 21, wherein the required pre-print information comprises a personal identification number.

25. The process of claim 21, wherein the required pre-print information comprises a room number.

26. The process of claim 21, wherein the required pre-print information comprises an expiration date.

27. The process of claim 21, wherein the required pre-print information comprises an email address.

28. The process of claim 21, further comprising providing an accounting database that cross-references each network printer to the associated accounting server.

29. The process of claim 21, further comprising providing an accounting database that cross-references each accounting server to the corresponding required pre-print information.

30. The process of claim 21, wherein the pre-print protocol comprises a plurality of fields.

31. The process of claim 21, wherein the pre-print protocol comprises a customizable field.

32. The process of claim 21, further comprising sending the pre-print message to the associated accounting server.

33. The process of claim 32, wherein sending comprises sending the pre-print message via an http request.

34. The process of claim 32, further comprising waiting for a print authorization message from the associated accounting server.

35. The process of claim 21, further comprising:
receiving print summary information from the designated printer; and
using the received print summary information to create a post-print message in accordance with a post-print protocol.

36. The process of claim 35, wherein the post-print protocol comprises a plurality of fields.

37. The process of claim 35, wherein the post-print message comprises a total number of pages printed by the designated printer.

38. The process of claim 35, wherein the post-print message comprises a total number of cover pages printed by the designated printer.

39. The process of claim 35, wherein the post-print message comprises a total number of black-and-white pages printed by the designated printer.

40. The process of claim 35, wherein the post-print message comprises a total number of color pages printed by the designated printer.
